(19) United States
(12) Patent Application Publication
(10) Pub. No.: US 2002/0027358 A1
(43) Pub. Date: Mar. 7, 2002

(54) Drawing board for field work

(76) Inventor: Richard D. Peppers, Murfreesboro, TN (US)

Correspondence Address: Richard C. Litman, LITMAN LAW OFFICES, LTD., P. O. Box 15035, Arlington, VA, 22215, US

(21) Appl. No.: 09/925,452

(22) Filed: Aug. 10, 2001

Related U.S. Application Data
(60) Provisional application No. 60/230,873, filed on Sep. 7, 2000.

(51) Int. Cl. B42D 3/00; B42D 7/00; B42D 17/00

(52) U.S. Cl. 281/45

(57) ABSTRACT

A drawing board for field work is configured particularly for the engineering and contracting trade, for making rough on site sketches of construction and other layouts in the field. The present board comprises a rigid sheet of material having a recessed paper or sheet retaining area in its center, with a slightly raised periphery. The periphery is relatively wide, and includes a series of reference tables thereon. The recessed central area includes a sheet retaining clip at its upper edge, with a sheet retaining relief or slot formed in the opposite lower edge. The floor of the sheet retaining area may have a different color than the border area. The present drawing board is dimensioned particularly for “B” size (11 by 17 inch) paper in the central sheet retention area, as commonly used for drawings in the technical trades, with the outer border including a compass for orientation in the field.

### CROSS-REFERENCE TO RELATED APPLICATION

This application claims the benefit of U.S. Provisional Patent Application Serial No. 60/230,873, filed Sep. 7, 2000.

### BACKGROUND OF THE INVENTION

1. Field of the Invention

The present invention relates generally to drawing and writing implements and surfaces, and more specifically to a portable drawing board adapted particularly for use in the field by engineers, artists, and others who have need for such a device. The present board includes a recessed central area for securely holding drawing sheets therein, with the border area having a compass for orientation and providing an area for various engineering or other reference tables or information as desired.

2. Description of the Related Art

Oftentimes, written notes do not convey all the necessary information concerning a project. Engineers, contractors, and other technical professionals are generally trained to make sketches or other illustrations of a construction site to show the installation of electrical power line runs, water and sewer lines, building sites, etc., depending upon the nature of the project and the specific expertise of the professional.

In the past, such technical professionals have relied upon generic clipboards or the like to hold a sheet of paper and to provide a backing surface for drawing. However, engineering drawings are generally made on sheets larger than the standard 8.5 by 11 inch or “A” size sheets commonly used for writing, with most clipboards being dimensioned for these smaller sheets. Also, the typical clipboard does not provide any means for securing the paper at two opposite edges thereof, with the sheets often fluttering from their free edges in even the slightest breeze.

Illustrations are often developed in the field for other reasons as well. An example of such is the landscape artist, who may desire sketches of various sites before determining the layout for a final painting or artwork. Such artists require a working surface much in common with that required by an engineering or other technical professional in the field, i. e., a relatively large working area comprising a relatively firm surface to back the drawing or artwork, and means for securely holding the paper or other sheet in place while working.

The present drawing board responds to these needs of the artist and engineer, by providing a board having a relatively large size in order to hold a larger, “B” (11 by 17 inch) size sheet, which size is commonly used in the drawing up of site plans and other technical drawings. The present drawing board also includes means for securing paper thereto along two opposite edges thereof to preclude or at least greatly reduce drawing sheet movement due to wind in the outdoor environment, and a compass for orientation in the field. The border of the present drawing board may include various reference tables (e. g., electrical cable gauges, sizes, and resistances for electrical engineers, English and metric conversions for civil engineers, etc.). However, the present drawing board is also well adapted for art and sketch work by artists and others making landscape and related types of drawings and artwork, as well.

A discussion of the related art of which the present inventor is aware, and its differences and distinctions from the present invention, is provided below.

U.S. Pat. No. 2,284,501 issued on May 26, 1942 to Herman P. Welch, titled “Time Study Board,” describes a simple clipboard with a conventional clip along the upper edge thereof. The right side of the clip is removed, for clearance for a cutout for the user's hand. A holder for a stopwatch or the like is provided adjacent the hand cutout. The Welch board, with its relatively tall aspect ratio, is not configured for larger “B” size drawing sheets, as is the present board. Moreover, Welch does not provide for securing the drawing sheets at their opposite edges, and teaches away from the present board by removing a portion of his paper retaining clip. In addition, Welch does not provide a recess for further paper security, nor a compass or the like for orientation. The watch holder area of the Welch board cannot be used to hold a compass, due to the metal (spring clips, studs, screws, etc.) used in its construction and attachment. The present drawing board includes such features for greater practicality in the outdoors.

U.S. Pat. No. 2,489,165 issued on Nov. 22, 1949 to Raymond D. Smith, titled “Drafting Board,” describes a rectangular board having sheet retaining clips disposed along two adjacent sides. No sheet retaining recess is formed in the center of the board, as provided by the present drawing board. Smith does not provide a compass for field orientation, nor any form of engineering or other reference tables or information with his board, as provided in the present drawing board. Moreover, Smith specifically notes in FIG. 3 of the drawings, that the maximum sheet size which his board will accommodate is 11 by 14¼ inches, which is smaller than the standard 11 by 17 inch “B” size sheet accepted by the present drawing board.

U.S. Pat. No. 2,881,009 issued on Apr. 7, 1959 to John R. Delaney, titled “Writing Board,” describes a clipboard having a conventional metal clip at the top thereof. The board is ergonomically configured, but no paper retaining means is provided except for the single conventional clip at the top. The Delaney board includes a holder for a pair of stopwatches, and a set of actuating arms for starting, stopping, and zeroing the watches. The holder and arms appear to be formed of metal, as is the adjacent clip at the top of the board, which would result in inaccuracies if a compass were to be installed in the watch holder portion of the device. No recess for retaining paper sheets, nor any reference tables or the like, are provided by Delaney, as provided in the present drawing board invention.

U.S. Pat. No. 3,352,616 issued on Nov. 14, 1967 to Harrison K. Linger, titled “Artist's Palette,” describes a device bearing a closer resemblance to a thin, flat case than to a drawing board. In fact, Linger does not provide a drawing or painting surface for his palette, but rather provides the conventional functions of a palette, i. e., a device for holding paints and brushes, in a device having closure means and removable legs. Accordingly, Linger does not provide any means of retaining a drawing sheet on his palette, nor does he provide a compass or any engineering or other reference tables, as his palette is not intended to be referred to visually on a regular basis, as is the drawing board of the present invention.

U.S. Pat. No. 4,148,506 issued on Apr. 10, 1979 to Terrence R. Lamb, titled “Portable Drawing Board,” describes a rectangular board having removable upper marginal edges. The drawing sheet is clamped between the edges and the underlying surface, to secure the paper to the board. Lamb uses threaded fasteners to secure the removable edges, which procedure is considerably more cumbersome than the single lower retaining slot and upper spring clip used with the present drawing board. Moreover, Lamb does not provide a compass or any form of engineering or other reference tables with his drawing board, which features are a part of the present drawing board invention.

U.S. Pat. No. 4,375,296 issued on Mar. 1, 1983 to Shih H. Chang, titled “Clipboard,” describes a specific clip configuration disposed at the upper edge of an otherwise conventional clipboard. Chang does not provide a recessed central area for retaining paper, nor any means of retaining sheet materials along the lower edge of his board opposite the clip. Moreover, no reference tables or compass are disclosed by Chang, as provided in the present drawing board invention.

U.S. Pat. No. 4,603,883 issued on Aug. 5, 1986 to Raul Barbieri et al., titled “Paper Sheet Carrying Board Provided With Clip And Closable Seat For Containing Writing Articles,” describes a board having a retaining clip at the top edge thereof, and a raised periphery. The lower edge of the periphery includes a hollowed area with an axially rotatable cover, for storing writing implements and the like. However, the raised edge of the Barbieri et al. board is much too narrow to provide any significant reference tables or means thereon, as provided by the present drawing board. Moreover, Barbieri et al. fail to provide a retaining groove opposite the clip, or a compass for orientation, which groove and compass are parts of the present drawing board invention.

U.S. Pat. 4,998,185 issued on Mar. 5, 1991 to Michael J. DeNigris, Jr., titled “Multi-Purpose Navigation Board,” describes a relatively small board having a sheet retaining clip disposed at the upper edge thereof. The board includes means for removable attachment to an aircraft control yoke, or alternatively to the upper thigh of a seated person (e. g., pilot of an aircraft). An extension lug or ear provides for the removable attachment of a stopwatch or the like thereto, for ease of reference for timing during navigation. No peripheral sheet retaining means is disclosed, but DeNigris, Jr. does provide a clear plastic overlay to secure an approach plate or the like on his board, while providing for making temporary notes on the plastic overlay. This teaches away from the present drawing board, as it is desired to draw or mark directly upon the sheet retained in the present board, rather than to avoid marking on it, as is the case with the National Oceanic Survey instrument approach plates to which the DeNigris, Jr. board is directed. Moreover, while DeNigris, Jr. provides for the removable attachment of a stopwatch or the like to his board, he does not disclose any provision for a compass, as compasses are required instruments in all powered aircraft, and such powered aircraft in which the DeNigris, Jr. board would be used, would already be equipped with a compass in any event. Moreover, the DeNigris, Jr. board is much too small for use with a relatively large “B” size drawing sheet or the like, as NOS approach plates are only about six by eight inches in size. A larger board to accommodate larger sheets would be excessively cumbersome in the relatively small confines of an aircraft cockpit

U.S. Pat. No. 5,441,228 issued on Aug. 15, 1995 to Thomas H. Geborek, titled “Document Holding And Display Device,” describes a device for holding and displaying larger drawing sizes from “B” size sheets on up. The device comprises two rigid sheets or boards which are hinged together along one edge, with clearance provided for a sheet retaining clip along their joined edges. Sheet retaining flanges are provided along the upper and lower edges of the device. The Geborek device provides only for the display and retention of large sheets, and does nothing to provide a generally flat and level surface for drawing on such a sheet, as provided by the present invention. Moreover, Geborek does not provide a compass for orientation in the field, nor does he provide a border area with engineering or other reference tables or means thereon, as provided by the present drawing board invention.

U.S. Pat. No. 5,516,151 issued on May 14, 1996 to John W. Mund et al., titled “Clipboard,” describes a device differing from earlier flat, conventional clipboards primarily in that it includes opposed lateral ridges for retaining paper sheets or the like therein. The Mund et al. board is primarily adapted to preclude angular twisting of a sheet(s) of paper during writing or drawing thereon, as might be the case with conventional clipboards. However, Mund et al. do nothing to retain the lower edge of a sheet of material held in their board. Moreover, the Mund et al. board is too small for use with “B” size sheets, having a width of only about 9½ inches (column 3, line 17). Mund et al. also fail to provide margin width for reference tables or a compass.

U.S. Pat. No. 5,823,574 issued on Oct. 20, 1998 to Patrick H. Sullins et al., titled “Writing Board With Padded Surface,” describes a clipboard having a padded backing surface and including an article retaining net thereacross. The board has a hard writing or drawing surface on the side or surface opposite the padded surface, including a sheet retaining clip and opposed lateral retaining lips. No sheet retaining means is provided opposite the retaining clip, nor is the marginal area provided wide enough for inclusion of any reference tables or the like thereon, as provided by the present drawing board. Also, Sullins et al. do not provide a compass with their board, which is a part of the present drawing board invention.

U.S. Pat. No. D-38,127 issued on Jul. 10, 1906 to Samuel E. Whiting, titled “Register Holding Frame,” illustrates a design having a first raised edge with opposed raised edges of lesser height extending from the first raised edge. The first raised edge includes a series of indeterminate features thereon, with the opposed raised edges having relatively wide areas, but failing to include any other features therein. The Whiting design does not provide a hand hold, sheet retaining clip, opposite retaining groove for holding the edges of sheets opposite the clip, engineering reference tables, or compass, as provided by the present drawing board invention.

U.S. Pat. No. D-279,489 issued on Jul. 2, 1985 to Kai S. Mak, titled “Drawing Toy,” illustrates a design having a relatively narrow rectangular border surrounding an apparently transparent writing or drawing surface. A hand hold is provided along the upper edge of the design. No sheet retaining means, engineering reference or other tables, or compass, is apparent in the Mak design.

U.S. Pat. No. D-327,498 issued on Jun. 30, 1992 to James E. Watson, titled “Drawing Screen,” illustrates a design having a trapezoidally shaped perimeter with an apparently transparent rectangular writing or drawing surface therein. While a hand hold is provided to one side of the trapezoidal frame, no sheet retaining means, compass, or reference tables are apparent in the Watson design.

U.S. Pat. No. D-345,177 issued on Mar. 15, 1994 to Kai-Shun Mak, titled “Drawing Board,” illustrates a design which somewhat resembles that of the '489 U.S. Design patent to the same inventor, discussed further above. The upper area of the '177 design appears to include further features than does the '489 design, but otherwise the same differences and distinctions noted between the '489 U.S. Design patent and the '177 design are seen to apply here as well.

U.S. Pat. No. D-359,984 issued on Jul. 4, 1995 to Kai-Shun Mak, titled “Drawing Board,” illustrates a design having a rounded rectangular, apparently transparent central writing or drawing area with relatively wide left and right borders. The left border includes a series of geometric shapes, but no reference tables are indicated in the Mak '984 design. Moreover, the '984 design does not appear to include any hand hold means, sheet retaining means, reference tables, or compass, as provided by the present drawing board invention.

U.S. Pat. No. D-359,985 issued on Jul. 4, 1995 to Kai-Shun Mak, titled “Drawing Board,” illustrates another variation on such a board by the same inventor as that of the '489, '177, and '984 U.S. Design patents discussed further above. The apparently transparent marking surface is offset to the right, with a relatively wide marginal area including a series of geometric, control-like features thereon. While this design includes a handhold, it does not provide any sheet retaining means, reference tables, or compass, all of which are provided in the present board.

U.S. Pat. No. D-418,877 issued on Jan. 11, 2000 to Gregory R. Brotz, titled “Illuminated Clipboard With Storage Compartment,” illustrates a design having a relatively thick upper end which tapers to a thinner lower section. No inset for retaining paper, hand hold, compass, or reference tables or the like are apparent in the Brotz design, each of which features are a part of the present drawing board invention.

U.S. Pat. No. 419,599 issued on Jan. 25, 2000 to KaiShun Mak, titled “Toy Drawing Board,” illustrates generally square configuration having a sinusoidal outer perimeter and a square, transparent drawing area in the center. While a hand hold is provided along the upper edge of the design, no sheet retaining means, compass, or reference tables are apparent.

U.S. Pat. No. D-428,927 issued on Aug. 1, 2000 to Chun Yuan Chang, titled “Clip Board And Case Combination,” illustrates a design which tapers in thickness from the upper to the lower end, somewhat like the Brotz '877 U.S. patent design discussed further above. A sheet retaining clip is provided along the upper edge, with a hand hold through the lower edge of the device. However, no other sheet retaining means are apparent, nor are any reference tables, inset area for retaining sheet materials, or compass apparent in the Chang design.

Canadian Patent No. 638,239 issued on Mar. 13, 1962 to Charles O. Sutton, titled “Clipboard,” describes a paper or sheet retaining clip for such a board. The clip includes a pivotally mounted extension which may be swung outwardly from one end of the clip, to provide better leverage when manipulating the clip. While such a clip might be used with the present drawing board invention, Sutton does not disclose any other features of a drawing or clipboard, particularly those features associated with the present drawing board invention.

Canadian Patent Publication No. 858,877 issued on Dec. 22, 1970 to Renzo Carniel, titled “Clipboard,” describes a board having a clip somewhat like that of the Sutton '239 Canadian Patent discussed above, but including a detachable overlying board. No other peripheral sheet retaining means, sheet holding recess, reference tables, or compass is provided with the Carniel clipboard, each of which features are a part of the present drawing board invention.

British Patent Publication No. 2,188,867 published on Oct. 14, 1987 to David M. Pike, titled “A Clipboard,” describes a monolithically formed board wherein the clip comprises a live hinge or spring formed integrally with the remainder of the board structure. No depression for holding paper sheets, reference tables, or compass are provided with the Pike clipboard.

PCT Publication No. WO91/17,058 published on Nov. 14, 1991 to Carsten Arnt-Jensen, titled “Device In Connection With A Supporting Board, Especially For The Support Of Paper Sheets Or Similar,” describes a clipboard having a series of peripheral clips for sheet retention, and a hinged flap at the upper edge thereof. While the hinged flap may include a series of sheet storage pockets and/or apparently some form of indicia thereon, it does not serve to hold the paper to the board. Moreover, the Arnt-Jensen device does not include a hand hold, peripheral reference tables, recessed sheet retaining means, or a compass, each of which features are a part of the present drawing board invention.

Finally, European Patent Publication No. 644,395 published on Mar. 22, 1995 to Werner Salansky illustrates a portable writing board apparently including an internal paper storage area. No peripheral sheet retaining means (other than an apparently conventional clip at the upper edge) is provided, nor are any reference tables, hand hold, or compass apparent in the '395 European Publication.

None of the above inventions and patents, taken either singly or in combination, is seen to describe the instant invention as claimed.

### SUMMARY OF THE INVENTION

The present invention comprises a drawing board which is particularly adapted for engineering use in the field, and which is also useful to the artist in the field environment, away from the studio. The present board comprises a rigid, generally rectangular sheet of material with an inset central area dimensioned for receiving one or more sheets of drawing paper, preferably of “B” size (11 by 17 inches). The upper edge of the sheet retention area includes a sheet retaining clip, while the opposite lower edge includes a slot or relief therein for precluding movement of the lower edge of the sheet(s) held in the board. The outer border of the device is preferably relatively wide, in order to include a series of engineering or other reference tables thereon. A compass is provided on the board, for orientation in the field while drawing up preliminary sketches on site.

Accordingly, it is a principal object of the invention to provide an improved drawing board for field work, for use by engineers, artists, and others who have need for such a drawing board configuration.

It is another object of the invention to provide an improved drawing board having a central sheet retaining area dimensioned to securely hold one or more “B” size drawing sheets therein.

Yet another object of the invention is to provide an improved drawing board with a sheet retaining area which may have a contrasting color for reducing eye strain.

It is a further object of the invention to provide an improved drawing board having an upper sheet retaining clip and an opposite, lower sheet retaining slot or relief to hold one or more sheets of paper or other sheet material by its opposite edges.

An additional object of the invention is to provide an improved drawing board having a relatively wide border area, for display of engineering and/or other reference tables thereon.

Still another object of the invention is to provide an improved drawing board including a magnetic compass for orientation in the field.

It is an object of the invention to provide improved elements and arrangements thereof in an apparatus for the purposes described which is inexpensive, dependable and fully effective in accomplishing its intended purposes.

These and other objects of the present invention will become apparent upon review of the following specification and drawings.

### BRIEF DESCRIPTION OF THE DRAWINGS

FIG. 1 is a perspective view of the present drawing board, showing its general features and components.

FIG. 2 is a broken away perspective view of the present drawing board, showing further details of the construction and lower sheet retaining recess thereof.

Similar reference characters denote corresponding features consistently throughout the attached drawings.

### DETAILED DESCRIPTION OF THE PREFERRED EMBODIMENTS

The present invention comprises a drawing board which is particularly adapted and configured for making sketches and drawings in the field, for use by engineers, contractors, artists, and others who have need to produce sketches and drawings where sophisticated drafting and illustrating equipment is not available. The present board, designated by the reference numeral 10 throughout the drawing Figures, includes at least one rigid, generally rectangular plate of material 12 (two or more plates may be laminated together, if desired), with a sheet retaining recess 14 formed generally centrally in the plate 12. The sheet retaining recess 14 is configured for the seating or placement of one or more drawing sheets therein (paper, Vellum, Mylar, etc., as desired), to hold the drawing sheet(s) securely therein. Preferably, the recess 14 is dimensioned for a “B” size drafting sheet having a width and height respectively of seventeen by eleven inches.

Accordingly, the recess area 14 preferably has a corresponding width 16 just slightly larger than the seventeen inch nominal width of such “B” size sheets, and a height 18 just slightly smaller (for reasons explained further below) than such “B” drawing sheets. It is noted that the present drawing board may be formed to provide for other sheet sizes, if so desired, but the “B” size sheet is a standard in the industry, with a large number of technical drawings being made using such a sheet size. This size also provides a reasonably large area for an artist to sketch or draw, without the dimensional limitations of smaller sheets and clipboards.

The drawing sheet recess 14 is surrounded by a relatively wide and flat raised border area 20, which defines the dimensions of the recess 14 and also the outer periphery of the board 10. The upper surface 22 of the border area 20 is relatively wide, as noted above, with this border upper surface area 22 providing for the display of additional information thereon, e. g., one or more (preferably a plurality of) conventional reference tables 24 disposed thereon. These tables 24 may contain information for the civil, electrical, and/or mechanical engineer in the field, e. g. electrical resistances for various cable lengths and diameters, diameters and cross sectional areas of circular section culverts, fractional and decimal equivalents, length and area conversion factors, etc., as desired. It will be seen that such tables 24 may be provided for specific fields, and may even include references of interest to the artist, e. g., color mixing guides, pencil hardness tables, etc., as desired

The border area 20 also provides room for additional features, such as a magnetic compass 26 for orientation in the field, and a hand hold opening 28 which passes through the border area 20 of the board 10, to facilitate carriage and transport of the board 10. The compass 26 may be recessed into the raised border area 20 of the board 10, if so desired, in order to reduce the overall thickness of the board 10 with the relatively thick compass 26 installed thereon. Preferably, the plate(s) 12 from which the board 10 is manufactured, is/are formed of a relatively high density plastic material (e. g., high density polyethylene, or HDPE; polyvinyl chloride, or PVC; etc.). Such materials are quite durable in the intended environment of the present drawing board 10, provide a good backing surface for drawing, and moreover are non-magnetic, in order to preclude any induced compass errors.

The first or upper inner edge 30 of the border area 20 includes a sheet clip recess 32 formed generally centrally therealong, in which a sheet retaining clip 34 is installed (e. g., by rivets or other mechanical fasteners 36, or adhesive or other means as desired). The clip 34 may comprise a conventional spring biased wire bail, as shown in the drawing Figures, or a conventional stamped sheet metal or plastic clip, etc., as desired. In any case, the clip mechanism 34 is set back into the clip retaining recess 32 with only the actual sheet or paper gripping portion of the clip 34 extending outwardly from the upper edge recess 32 to maximize the border area 20 therealong and reduce unused space along the upper edge of the sheet retaining recess 14.

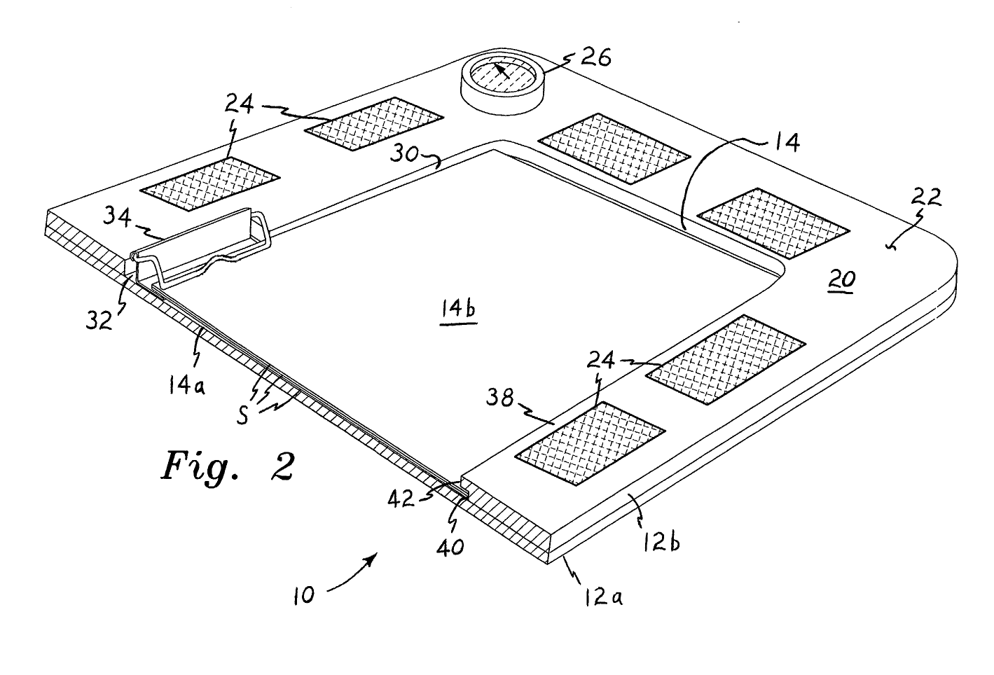

The opposite second or lower inner edge 38 of the recessed central area 14 is also structured to secure the edge of one or more drawing sheets therein, with this sheet retaining relief 40 being shown in FIG. 2 of the drawings. The relief 40 forms a paper or drawing sheet edge retaining slot extending along the entire length of the second inner edge 38 of the central recessed area 14, with the relief or slot 40 being defined by an overlying lip 42 which extends from the second inner edge 38 of the border area 20. This relief or sheet retaining slot 40 need not be particularly deep, perhaps on the order of one quarter inch or so, just sufficient to tuck the lower edge(s) of the drawing sheet(s) S therein for retention of those lower sheet edges.

While it is possible to form such an inwardly oriented slot or recess in a drawing board 10 formed of a single, unitary plate 12 of material, FIG. 2 illustrates the construction of the present board 10 using a first or base plate 12a, which is continuous and unbroken throughout its length and width to form a solid, unbroken central sheet support area 14a. The second or border plate 12b includes an open center area 14b, with the border plate 12b being laminated atop the base plate 12a and in registry therewith, to define the drawing sheet retaining recess 14b therein. The border plate 12b may have a groove routed, cast, or otherwise formed along its lower inner edge 38 opposite the upper surface 22, before assembly with the base plate 12a. Upon assembly with the base plate 12a, the groove of the border plate 12b forms the sheet retaining relief or slot 40 of the board 10 shown in FIG. 2.

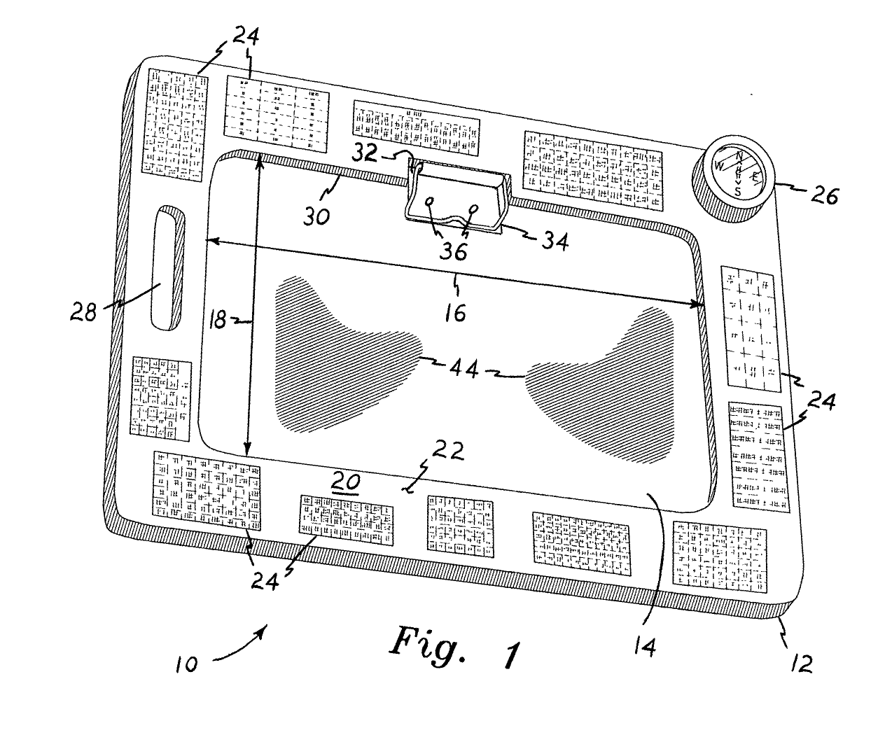

Assembling the board 10 of two separate plies of material provides other benefits, as well. Preferably, the upper surface 22 of the border plate 12b is white, or at least formed of a relatively light color, in order to provide good background for the darker characters forming the tables 24 provided thereon. However, a more contrasting color might be preferable as a background to the generally white drawing sheets S placed within the central area 14b of the board. It has been shown that a light or medium green, indicated by the color shading 44 of the central area 14 of the board 10 of FIG. 1, is restful on the eyes and provides a good background for placement of drawing sheets S thereon. Other colors may be provided as desired. Preferably, this colored or shaded drawing surface 44 has a non-reflective, matte finish, to preclude glare and to provide a good underlying surface for drawing or writing.

The contrasting colors and/or finishes of the border area 20 and drawing sheet area 14 (or 14a) may be achieved by means of the above described laminated construction shown in FIG. 2 of the drawings. By providing a backing plate or board 12a of the desired color and finish texture, in combination with a border plate or board 12b, the desired contrasting colors and/or textures are easily achieved without need for any additional finishing work upon the board 10. Alternatively, the board 10 may be formed of a single, unitary component, with the central area 14 being colored and finished as desired and the undercut sheet retaining slot 40 molded or otherwise formed therein, as noted further above.

In conclusion, the present drawing board provides a much needed accessory for the technical professional who has need to produce drawings and sketches in the field. The size of the present board provides for proper placement and retention of “B” size drawing sheets in the central sheet retaining area, with the recessed sheet retaining clip and opposite sheet retaining slot or relief providing secure retention of one or more drawing sheets within the board, by the opposite edges of the sheet(s). The provision of a relatively wide border area, with room for various reference tables or other information thereon, a magnetic compass for orientation in the field, and a hand hold passage, provides further utility for the present drawing board.

The utility of the present drawing board is not limited only to engineering and contracting field work, but may be extended for use by artists and others who have occasion to produce sketches, drawings, paintings, and/or other two dimensional artwork in the field. The reference information noted on the border area of the board may be directed to subject areas of interest or importance to the artist or sketcher, rather than being limited to technical information for the engineer or contractor. In any event, the present board will prove most useful for engineers, contractors, artists, and anyone who must produce technical drawings or artwork in the field, away from a drafting or art studio.

It is to be understood that the present invention is not limited to the embodiments described above, but encompasses any and all embodiments within the scope of the following claims.

I claim:

1. A drawing board for field work, comprising:
at least one rigid, generally rectangular plate;
said plate including a sheet retaining recess formed generally centrally therein;
a wide, flat, raised border area surrounding said sheet retaining recess;
said border area including at least a first inner edge and a second inner edge opposite said first inner edge;
said border area further including a recess formed generally centrally along said first inner edge;
a sheet retaining clip installed within said recess of said first inner edge of said border area; and
said border area further including a sheet retaining relief defined by an overlying lip extending from said second inner edge of said border area, and generally opposite said sheet retaining clip of said recess of said first inner edge of said border area.

2. The drawing board according to claim 1, further including a magnetic compass installed upon said border area.

3. The drawing board according to claim 1, further including at least one reference table disposed upon said border area.

4. The drawing board according to claim 1, wherein at least one hand hold is formed through said border area.

5. The drawing board according to claim 1, wherein said at least one plate comprises:
a base plate having a continuous, unbroken central area defining a central sheet support area;
a border plate having an open center, the border plate being laminated atop said base plate and defining said sheet retaining recess; and
wherein said base plate and said border plate are colored with mutually contrasting colors to one another.

6. The drawing board according to claim 1, wherein said sheet retaining recess is dimensioned and configured for retaining at least one “B” size drawing sheet therein.

7. A drawing board for field work, comprising:
at least one rigid, generally rectangular plate;
said plate including a sheet retaining recess formed generally centrally therein;
a wide, flat, raised border area surrounding said sheet retaining recess;
sheet retaining means disposed about said sheet retaining recess for retaining a drawing sheet; and
a magnetic compass installed upon said border area.

8. The drawing board according to claim 7, wherein said border area has at least a first inner edge and a second inner edge opposite said first inner edge, a clip recess being defined generally centrally along said first inner edge, said sheet retaining means comprising:
a sheet retaining clip installed within said clip recess of said first inner edge of said border area; and
a sheet retaining relief defined by an overlying lip extending from said second inner edge of said border area, and generally opposite said sheet retaining clip of said clip recess of said first inner edge of said border area.

9. The drawing board according to claim 7, further including at least one reference table disposed upon said border area.

10. The drawing board according to claim 7, wherein at least one hand hold is defined through said border area.

11. The drawing board according to claim 7, wherein said at least one plate comprises:
a base plate having a continuous, unbroken central area defining a central sheet support area;
a border plate having an open center, the border plate being laminated atop said base plate and defining said sheet retaining recess; and
wherein said base plate and said border plate are colored with mutually contrasting colors to one another.

12. The drawing board according to claim 7, wherein said sheet retaining recess is dimensioned and configured for retaining at least one “B” size drawing sheet therein.

13. A drawing board for field work, comprising:
at least one rigid, generally rectangular plate;
said plate including a sheet retaining recess formed generally centrally therein;
a wide, flat, raised border area surrounding said sheet retaining recess;
sheet retaining means disposed about said sheet retaining recess for retaining a drawing sheet; and
at least one reference table disposed upon said border area.

14. The drawing board according to claim 13, wherein said border area includes at least a first inner edge and a second inner edge opposite said first inner edge, a clip recess being defined generally centrally along said first inner edge, said sheet retaining means comprising:
a sheet retaining clip installed within said clip recess of said first inner edge of said border area; and
a sheet retaining relief defined by an overlying lip extending from said second inner edge of said border area, and generally opposite said sheet retaining clip of said clip recess of said first inner edge of said border area.

15. The drawing board according to claim 13, further including a magnetic compass installed upon said border area.

16. The drawing board according to claim 13, wherein at least one hand hold is defined through said border area.

17. The drawing board according to claim 13, wherein said at least one plate comprises:
a base plate having a continuous, unbroken central area defining a central sheet support area;
a border plate having an open center, the border plate being laminated atop said base plate and defining said sheet retaining recess; and
wherein said base plate and said border plate are colored with mutually contrasting colors to one another.

18. The drawing board according to claim 13, wherein said sheet retaining recess is dimensioned and configured for retaining at least one “B” size drawing sheet therein.
